(19) United States
(12) Patent Application Publication
(10) Pub. No.: US 2017/0229016 A1
(43) Pub. Date: Aug. 10, 2017

(54) MOBILE AUTOMOBILE PARKING APPLICATION

(71) Applicant: Bixi Wang, Nantong (CN)

(72) Inventor: Bixi Wang, Nantong (CN)

(21) Appl. No.: 15/018,871

(22) Filed: Feb. 9, 2016

(51) Int. Cl. G08G 1/14

(52) U.S. Cl. CPC G08G 1/144

(57) ABSTRACT

This invention discloses a mobile automobile parking application installed on a user equipment (UE). The UE may be a mobile smart phone, a tablet or a portable computer. The UE is connected to a server through a wireless network. The mobile automobile parking application enables a user to report to the server a successful parking event (finding a parking space) or a failed parking event (not finding a parking space). The mobile automobile parking application also allows the user to report to the server when the user is leaving a parking space, seeing other drivers leaving parking spaces, or seeing other available parking spaces. (Therefore, one or more parking spaces will be available). The user may report parking rates to the server. The mobile automobile parking application automatically transmits the parking location to the server when the user reports the successful parking event, the failed parking event or leaving the parking space using geolocation. The mobile automobile parking application allows the user to find previous successful parking events, previous failed parking events or available parking spaces through data stored in the server.

### FIELD OF THE INVENTION

This invention relates generally to a mobile automobile parking application. More particularly, the present invention relates to a mobile automobile parking application including parking information updated by users.

### BACKGROUND OF THE INVENTION

A user of a mobile device commonly uses a Global Positioning System (GPS) or a navigation system to guide the user to a destination. It is advantageous if the GPS or the navigation system also provides the user parking information.

### SUMMARY OF THE INVENTION

This invention discloses a mobile automobile parking application installed on a user equipment (UE). The UE may be a mobile smart phone, a tablet or a portable computer. The UE is connected to a server through a wireless network. The mobile automobile parking application enables a user to report to the server a successful parking event (finding a parking space) or a failed parking event (not finding a parking space). The mobile automobile parking application also allows the user to report to the server when the user is leaving a parking space, seeing other drivers leaving parking spaces, or seeing other available parking spaces. (Therefore, one or more parking spaces will be available). The user may report parking rates to the server. The mobile automobile parking application automatically transmits the parking location to the server when the user reports the successful parking event, the failed parking event or leaving the parking space using geolocation. The mobile automobile parking application allows the user to find previous successful parking events, previous failed parking events or available parking spaces through data stored in the server.

### BRIEF DESCRIPTION OF THE DRAWINGS

FIG. 1 is a flowchart of a method for using a mobile automobile parking application in examples of the present disclosure.

FIG. 2A and FIG. 2B show user interfaces of the mobile automobile parking application in examples of the present disclosure.

FIG. 3 shows signs of the mobile automobile parking application in examples of the present disclosure.

### DETAILED DESCRIPTION OF THE INVENTION

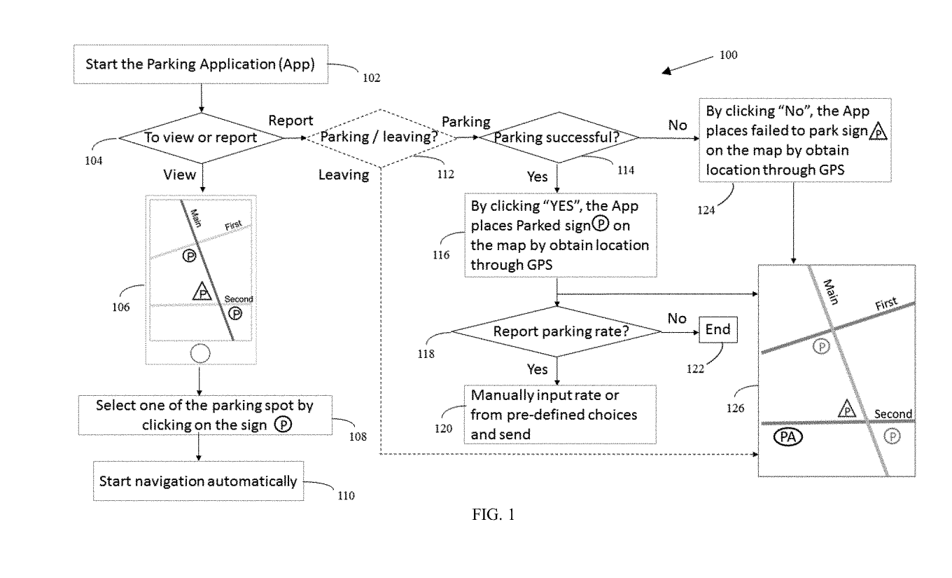

FIG. 1 is a flowchart of a method 100 for using a mobile automobile parking application (App) installed on a UE in examples of the present disclosure. The method 100 may begin in block 102.

In block 102, a user starts the mobile automobile parking application. Block 102 may be followed by block 104.

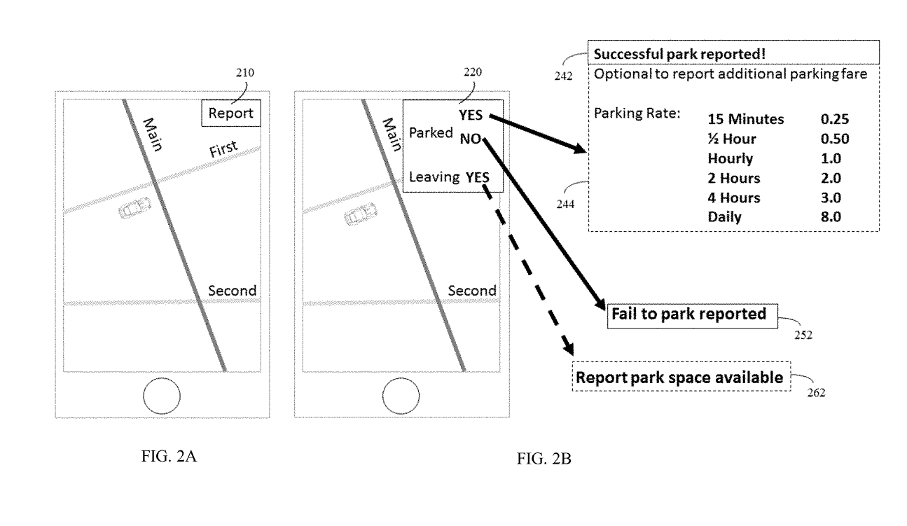

In block 104, a user determines if to view parking information or to report parking events. If the user determines to view parking information, block 104 may be followed by block 106. If the user determines to report parking events, the user may apply a gesture on a report icon 210 of FIG. 2A to select to report parking events. Block 104 may be followed by optional block 112 (shown in dashed lines) or block 114.

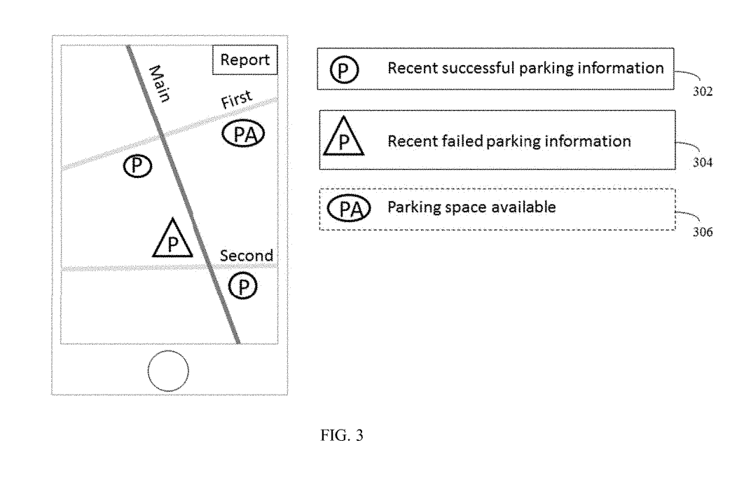

In block 106, parking information represented by signs appear on a display of the UE. The parking information may be transferred from a server through a network to the UE. In examples of the present disclosure, signs are shown in FIG. 3. A letter “P” with a surrounding circle represents a successful parking event 302. A letter “P” with a surrounding triangle represents a failed parking event 304. An optional sign, “PA” with a surrounding oval, represents an event of available parking space 306. In examples of the present disclosure, the parking information includes successful parking events and failed parking events in a pre-determined time period (in one example, within 30 minutes) and in a pre-determined region (in another example, 3 miles from the destination). Block 106 may be followed by block 108.

In block 108, a user applies a gesture on one of the signs of successful parking events. In examples of the present disclosure, the gesture may be a single-touch, a single-click, a double-touch, a double-click, or a press-and-hold. Block 108 may be followed by block 110.

In block 110, a GPS or a navigation system guides the user to the location of the selected successful parking event.

In optional block 112, the user determines if to report parking events or to report available parking spaces. If the user determines to report parking events, optional block 112 may be followed by block 114. If the user determines to report available parking spaces, the user applies a gesture on “Leaving—YES” icon in area 220 of FIG. 2B. The user is then interacts with “reporting available parking spaces” 262 of FIG. 2B of the application. The App will forward the user's location to the server through a network and a sign of available parking space 306 appears in a display 126. Reported available parking spaces may include a parking space being available after the user leaves the parking space, parking spaces being available after the user sees other drivers leaving the parking spaces, and open parking spaces noticed by the user. Based on track records of accuracy of parking events of the user, the server may determine if to publish the reported parking events.

In block 114, the user determines if it is a successful parking event. If so, block 114 may be followed by block 116. If not so, block 114 may be followed by block 124.

In block 116, the user applies a gesture on “Parked—YES” icon in area 220 of FIG. 2B. The successful parking event 242 of FIG. 2B and the user's location are transferred to the server through a network. The map in the display 126 may be updated with a sign of a successful parking event 302. Based on track records of accuracy of parking events of the user, the server may determine if to publish the reported successful parking event. Block 116 may be followed by block 118 and display 126.

In block 118, the user determines if to report parking rates. If so, block 118 may be followed by block 120. If not so, block 118 may be followed by block 122.

In block 120, the user optionally reports parking rates 244.

In block 122, no parking rates are reported.

In block 124, the user applies a gesture on “Parked—NO” icon in area 220 of FIG. 2B. The failed parking event 252 of FIG. 2B and the user's location are transferred to the server through a network. The map in the display 126 may be updated with a sign of a failed parking event 304. Based on track records of accuracy of parking events of the user, the server may determine if to publish the reported failed parking event. Block 124 may be followed by display 126.

Display 126 may include a map with real-time reported parking events.

In examples of the present disclosure, the server includes a server processor, a server database and a server interface.

In examples of the present disclosure, the server maintains an accuracy rating for each user. In one example, the server assigns a 50% accuracy rating for a new user. The accuracy rating of the new user increases when a reported parking event by the new user receives positive feedback from other users. The accuracy rating of the new user decreases when the reported parking event by the new user receives negative feedback from other users. In another example, the server collected reported parking events in a pre-determined region during a pre-determined time period. If the counts of successful parking events is more than the counts of failed parking events, the server increases the accuracy ratings of the users reporting successful parking events and reduces the ratings of the users reporting failed parking events. If the counts of successful parking events is less than the counts of failed parking events, the server reduces the accuracy ratings of the users reporting successful parking events and increases the ratings of the users reporting failed parking events.

Those of ordinary skill in the art may recognize that modifications of the embodiments disclosed herein are possible. For example, the shapes and letters of the signs of parking events of FIG. 3 may vary. Other modifications may occur to those of ordinary skill in this art, and all such modifications are deemed to fall within the purview of the present invention, as defined by the claims.

1. A method comprising:
receiving from a user equipment (UE) a parking information request, the parking information request including a pre-determined region and a pre-determined time period;
in response to receiving the parking information request, selecting and sorting parking data stored in a database, the selected and sorted parking data including stored successful parking events and stored failed parking events in the pre-determined region during the pre-determined time period;
transmitting the selected and sorted parking data to the UE;
receiving from the UE a parking feedback, the parking feedback including a timing of the parking feedback, a location of the UE, and a successful or failed status; and
updating the database by
storing the parking feedback as a successful parking event in response to a successful status of the parking feedback; and
storing the parking feedback as a failed parking event in response to a failed status of the parking feedback.

2. The method of claim 1, wherein the selected and sorted parking data further include stored parking rates and wherein the parking feedback further includes reported parking rates.

3. The method of claim 1, wherein the selected and sorted parking data further include stored available parking spaces and wherein the parking feedback further includes reported available parking spaces.

4. The method of claim 1, wherein the selected and sorted parking data further include accuracy ratings of users reporting the stored successful parking events and the stored failed parking events.

5. A system comprising:
a communication network;
a user equipment (UE) communicatively coupled to the communication network; and
a server communicatively coupled to the communication network for communication with the UE, the server being configured to perform functions to:
receive from the UE a parking information request, the parking information request including a pre-determined region and a pre-determined time period;
in response to receiving the parking information request, select and sort parking data stored in a database, the selected and sorted parking data including stored successful parking events and stored failed parking events in the pre-determined region during the pre-determined time period;
transmit the selected and sorted parking data to the UE;
receive from the UE a parking feedback, the parking feedback including a timing of the parking feedback, a location of the UE, and a successful or failed status; and
update the database by
storing the parking feedback as a successful parking event in response to a successful status of the parking feedback; and
storing the parking feedback as a failed parking event in response to a failed status of the parking feedback.

6. The system of claim 5, wherein the selected and sorted parking data further include stored parking rates and wherein the parking feedback further includes reported parking rates.

7. The system of claim 5, wherein the selected and sorted parking data further include stored available parking spaces and wherein the parking feedback further includes reported available parking spaces.

8. The system of claim 5, wherein the selected and sorted parking data further include accuracy ratings of users reporting the stored successful parking events and the stored failed parking events.

9. A non-transitory computer-readable storage medium storing instructions that, when executed by one or more processors of a server, cause the server to perform a method, the method comprising:
receiving from a user equipment (UE) a parking information request, the parking information request including a pre-determined region and a pre-determined time period;
in response to receiving the parking information request, selecting and sorting parking data stored in a database, the selected and sorted parking data including stored successful parking events and stored failed parking events in the pre-determined region during the pre-determined time period;
transmitting the selected and sorted parking data to the UE;
receiving from the UE a parking feedback, the parking feedback including a timing of the parking feedback, a location of the UE, and a successful or failed status; and
updating the database by
storing the parking feedback as a successful parking event in response to a successful status of the parking feedback; and
storing the parking feedback as a failed parking event in response to a failed status of the parking feedback.

10. The non-transitory computer-readable storage medium of claim 9, wherein the selected and sorted parking data further include stored parking rates and wherein the parking feedback further includes reported parking rates.

11. The non-transitory computer-readable storage medium of claim 9, wherein the selected and sorted parking data further include stored available parking spaces and wherein the parking feedback further includes reported available parking spaces.

12. The non-transitory computer-readable storage medium of claim 9, wherein the selected and sorted parking data further include accuracy ratings of users reporting the stored successful parking events and the stored failed parking events.
